(19) United States
(12) Patent Application Publication
(10) Pub. No.: US 2012/0223912 A1
(43) Pub. Date: Sep. 6, 2012

(54) CAPACITIVE TYPE TOUCH SCREEN PANEL

(75) Inventor: Jung Won KIM, Suwon-si (KR)

(73) Assignee: SAMSUNG ELECTRONICS CO. LTD., Suwon-si (KR)

(21) Appl. No.: 13/371,867

(22) Filed: Feb. 13, 2012

(30) Foreign Application Priority Data
Mar. 4, 2011 (KR) 10-2011-0019408

(51) Int. Cl. G06F 3/044

(52) U.S. Cl. 345/174

(57) ABSTRACT

A Capacitive type (C-type) Touch Screen Panel (TSP) is provided. The C-type TSP includes a window for protecting the TSP, an upper transparent adhesive layer bonded under the window, an upper transparent conductive layer bonded under the upper transparent adhesive layer and for detecting a touch point on the window, an upper transparent insulating substrate disposed under the upper transparent conductive layer and formed with polymer of an isotropic material, a lower transparent adhesive layer bonded under the upper transparent insulating substrate, a lower transparent conductive layer bonded under the lower transparent adhesive layer and for detecting a touch point on the window, and a lower transparent insulating substrate disposed under the lower transparent conductive layer and formed with polymer of an isotropic material.

### PRIORITY

This application claims the benefit under 35 U.S.C. §119(a) of a Korean patent application filed on Mar. 4, 2011 in the Korean Intellectual Property Office and assigned Serial No. 10-2011-0019408, the entire disclosure of which is hereby incorporated by reference.

### BACKGROUND OF THE INVENTION

1. Field of the Invention

The present invention relates to a Capacitive type (C-type) Touch Screen Panel (TSP). More particularly, the present invention relates to a C-type TSP including two transparent conductive layers.

2. Description of the Related Art

A mobile terminal is an electronic device that enables a user to freely use a function of wireless communication, network connection, and digital broadcasting reception almost regardless of time and location. As electronic communication technology develops, the user can perform various functions with a mobile terminal. More particularly, a smart phone and a tablet Personal Computer (PC) download and install various applications through an application market, such as an App Store, unlike an existing mobile terminal using only a given function.

Nowadays, a touch screen is applied to a mobile terminal according to a user request.

A touch screen is an input device that enables an instruction to execute when a user touches the screen by hand or using a special device at a specific instruction language portion on a screen.

The touch screen is variously classified and includes a surface acoustic wave type, infrared beam type, resistive type, and capacitive type according to an operation principle. More particularly, the resistive type and the capacitive type are applied to a mobile terminal.

The resistive type has a structure of disposing a resistant film on glass or transparent plastic and covering, for example a polyester film at a predefined gap on the resistant film. The resistive type has a changing resistance value when a screen is touched and detects a touch point by detecting the changing resistance value. The resistive type is inexpensive to manufacture, but does not detect a touch point, unlike the capacitive type, when a screen is strongly pressed and gives a dull sense of touch.

FIG. 1 is a diagram illustrating an operation principle of a Capacitive type (C-type) Touch Screen Panel (TSP) according to the related art.

Referring to FIG. 1, a C-type TSP 10 is mounted on a Liquid Crystal Display (LCD) 20. The C-type TSP 10 disposes a transparent conductive layer on a transparent insulating substrate and generates a high frequency on a surface of the TSP 10 by applying a voltage to four corners of the TSP 10. The C-type TSP 10 processes a high frequency waveform changing in a processor when a finger touches on the C-type TSP 10 and calculates a touch point.

A C-type includes a single layer type that uses one transparent conductive layer and a dual layer type that uses two transparent conductive layers.

In the single layer type, accuracy of a touch point is deteriorated, compared with the dual layer type, and the single layer type is greatly influenced by, for example, the back of the hand or a wrist in addition to a finger. Therefore, the dual layer type is applied to a mobile terminal.

An existing dual layer type uses a transparent insulating substrate of an anisotropic material in consideration of performance against cost. Poly-Ethylene Terephthalate (PET) is a typical anisotropic material that can be applied to a TSP of a mobile terminal. Here, an anisotropic material is a material in which a property of crystal to light changes according to a direction of crystal. Therefore, an anisotropic material has a high birefringence rate and light absorption rate and thus has an image distortion phenomenon, but requires a relatively minimal cost and thus is often used for a TSP of a mobile terminal.

However, an image distortion phenomenon has no particular problem in a two-dimensional display environment, but has a problem in a three-dimensional display environment that needs to embody a three-dimensional effect. In other words, in a three-dimensional display environment, an image distortion phenomenon that causes a user's dizziness is a major problem that needs to be resolved.

Therefore, a need exists for a C-type TSP for a three-dimensional display that can reduce an image distortion phenomenon.

### SUMMARY OF THE INVENTION

Aspects of the present invention are to address the above-mentioned problems and/or disadvantages and to provide at least the advantages described below. Accordingly, an aspect of the present invention is to provide a Capacitive type (C-type) Touch Screen Panel (TSP) for a three-dimensional display that can reduce an image distortion phenomenon.

In accordance with an aspect of the present invention, a C-type TSP is provided. The TSP includes a window for protecting the TSP, an upper transparent adhesive layer bonded under the window, an upper transparent conductive layer bonded under the upper transparent adhesive layer for detecting a touch point on the window, an upper transparent insulating substrate disposed under the upper transparent conductive layer and formed with polymer of an isotropic material, a lower transparent adhesive layer bonded under the upper transparent insulating substrate, a lower transparent conductive layer bonded under the lower transparent adhesive layer for detecting a touch point on the window, and a lower transparent insulating substrate disposed under the lower transparent conductive layer and formed with polymer of an isotropic material.

In accordance with another aspect of the present invention, a C-type TSP is provided. The TSP includes a window for protecting the TSP, an upper transparent conductive layer disposed under the window for detecting a touch point on the window, a transparent adhesive layer bonded under the upper transparent conductive layer, a lower transparent conductive layer bonded under the transparent adhesive layer for detecting a touch point on the window, and a transparent insulating substrate disposed under the lower transparent conductive layer and formed with polymer of an isotropic material.

The transparent insulating substrate may be formed with PolyEthylene (PE) or Cyclic Olefin Copolymer (COC), the transparent conductive layer may be formed with Indium Tin Oxide (ITO), the two transparent conductive layers may be arranged in a lattice method, and the adhesive layer may be formed with an Optically Clear Adhesive (OCA).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the present invention will be more apparent from the following description taken in conjunction with the accompanying drawings, in which:

FIG. 1 is a diagram illustrating an operation principle of a Capacitive type (C-type) Touch Screen Panel (TSP) according to the related art;

FIG. 2 is a cross-sectional view illustrating a C-type TSP according to an exemplary embodiment of the present invention;

FIGS. 3 and 4 illustrate a lattice structure of two transparent conductive layers according to exemplary embodiments of the present invention; and

FIG. 5 is a cross-sectional view illustrating a C-type TSP according to an exemplary embodiment of the present invention.

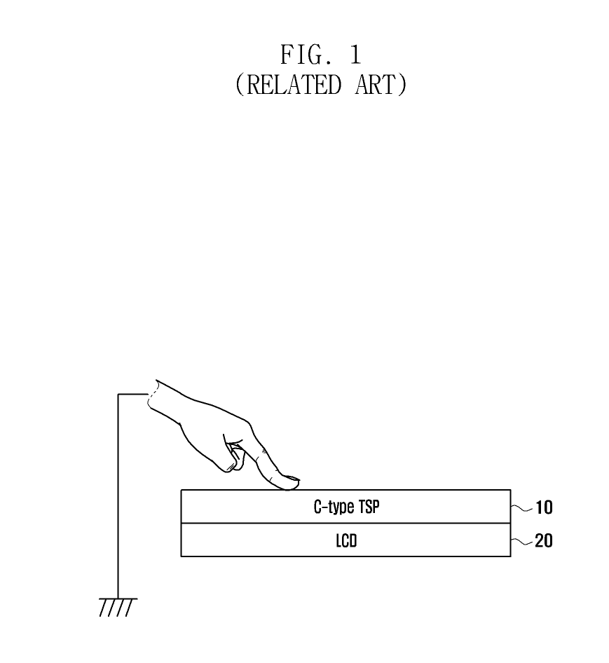

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a Capacitive type (C-type) Touch Screen Panel (TSP) that can be applied to electronic devices using as a main input device a TSP, such as an Automated Teller Machine (ATM), Personal Digital Assistant (PDA), tablet Personal Computer (PC), navigation device, a smart phone, and the like.

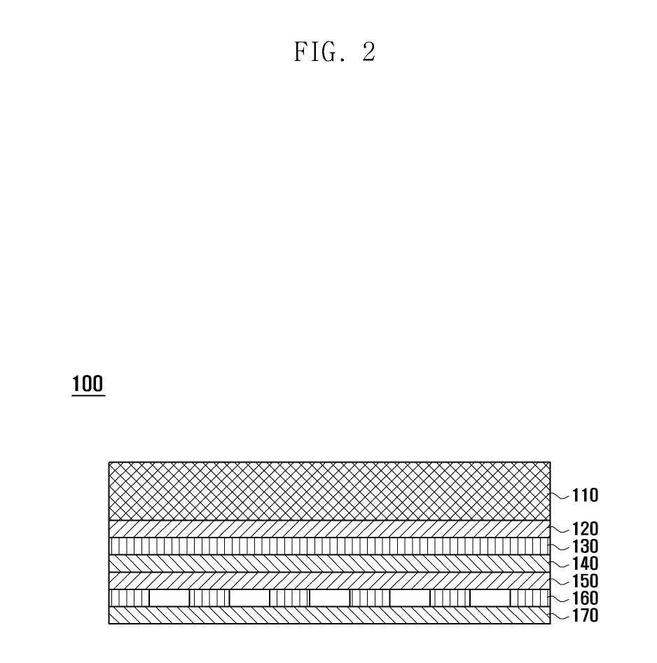

FIGS. 2 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 2 is a cross-sectional view illustrating a C-type TSP according to an exemplary embodiment of the present invention.

Referring to FIG. 2, a TSP 100 includes a window 110, an upper transparent adhesive layer 120, an upper transparent conductive layer 130, an upper transparent insulating substrate 140, a lower transparent adhesive layer 150, a lower transparent conductive layer 160, and a lower transparent insulating substrate 170.

The window 110 is positioned at the uppermost side of the TSP 100, provides a touch portion for a finger or other touch device, and protects the TSP 100. A separate protective film for protecting the window 110 may be disposed on the window 110, which is formed with glass.

The upper transparent adhesive layer 120 is positioned between the window 110 and the upper transparent conductive layer 130 and is used for bonding the window 110 and the upper transparent conductive layer 130. The upper transparent adhesive layer 120 is formed with an Optically Clear Adhesive (OCA), which is an optical transparent double-sided tape. This is because OCA has excellent viscosity and optical performance. However, a material of the upper transparent adhesive layer 120 is not limited thereto.

The upper transparent conductive layer 130 is positioned between the upper transparent adhesive layer 120 and the upper transparent insulating substrate 140 and is used for detecting a position and action of a touch by detecting a user's touch to the window 110. The upper transparent conductive layer 130 is coated on the upper transparent insulating substrate 140. The upper transparent conductive layer 130 is formed with Indium Tin Oxide (ITO), which is a transparent conductive film. This is because ITO has excellent conductivity and optical performance. However, a material of the upper transparent conductive layer 130 is not limited thereto.

The upper transparent insulating substrate 140 is positioned between the upper transparent conductive layer 130 and the lower transparent adhesive layer 150 and functions as a substrate of the upper transparent conductive layer 130. The upper transparent insulating substrate 140 is formed with polymer of an isotropic material. Here, an isotropic material is a material having a constant refractive index regardless of a passing direction of light. Therefore, an isotropic material has an improved image distortion phenomenon, compared with an anisotropic material. The upper transparent insulating substrate 140 is formed with glass instead of polymer, however, it may be formed with polymer in view of performance against cost. Furthermore, glass is heavier than polymer. Therefore, to reduce the weight of a mobile terminal, polymer is more effective than glass. The upper transparent insulating substrate 140 is formed with PolyEthylene (PE) or Cyclic Olefin Copolymer (COC) among polymer of an isotropic material. This is because PE or COC has excellent optical performance. However, a material of the upper transparent insulating substrate 140 is not limited thereto.

The lower transparent adhesive layer 150 is positioned between the upper transparent insulating substrate 140 and the lower transparent conductive layer 160 and is used for bonding the upper transparent insulating substrate 140 and the lower transparent conductive layer 160. The lower transparent adhesive layer 150 is formed with the same material as that of the upper transparent adhesive layer 120. However, a material of the lower transparent adhesive layer 150 is not limited thereto.

The lower transparent conductive layer 160 is positioned between the lower transparent adhesive layer 150 and the lower transparent insulating substrate 170 and is used for detecting a position and action of a touch by detecting a user's touch to the window 110. The lower transparent conductive layer 160 is coated on the lower transparent insulating substrate 170. The lower transparent conductive layer 160 is formed with the same material as that of the upper transparent conductive layer 130. However, a material of the lower transparent conductive layer 160 is not limited thereto.

The lower transparent insulating substrate 170 is positioned at the lowermost side of the TSP 100 and functions as a substrate of the lower transparent conductive layer 160. The lower transparent insulating substrate 170 is formed with polymer of the same isotropic material as that of the upper transparent insulating substrate 140. More particularly, the lower transparent insulating substrate 170 is formed with PE or COC, as in the upper transparent insulating substrate 140. A display panel is positioned under the lower transparent insulating substrate 170. Light generated in the display panel transmits the TSP 100.

When a user touches the window 110 with a finger, a change occurs in a high frequency waveform applied to the two transparent conductive layers 130 and 160 by static electricity of a human body. The two transparent conductive layers 130 and 160 output a signal according to such a waveform change to a processor. The processor calculates a touch point by processing a signal that receives from the two transparent conductive layers 130 and 160.

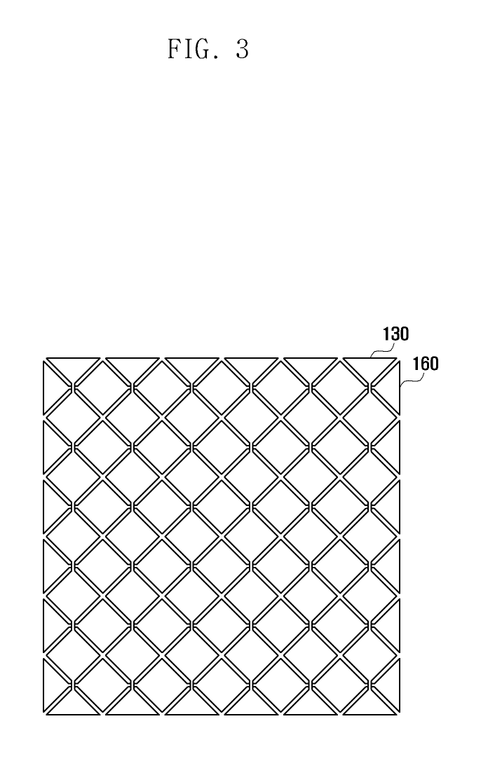

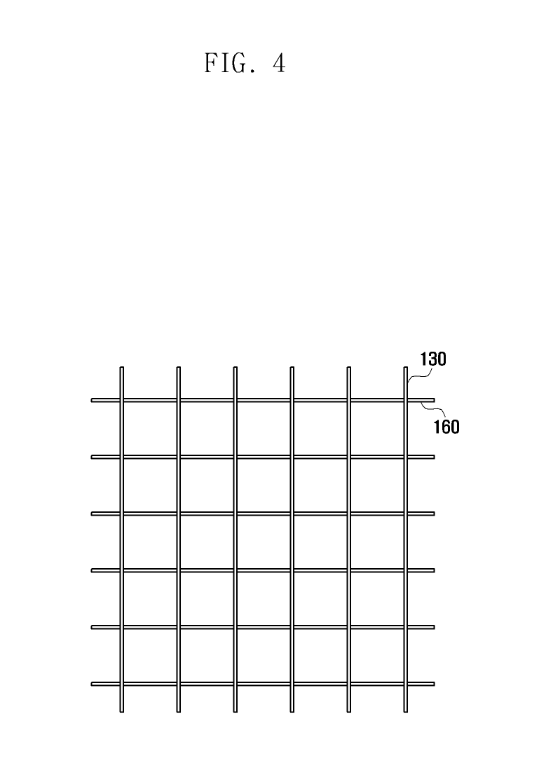

FIGS. 3 and 4 illustrate a lattice structure of two transparent conductive layers according to exemplary embodiments of the present invention.

Two transparent conductive layers, 130 and 160, are arranged in a lattice method. For example, when the upper transparent conductive layer 130 is arranged in parallel in an X-axis direction, the lower transparent conductive layer 160 is arranged in parallel in a Y-axis direction.

Referring to FIG. 3, in the two transparent conductive layers 130 and 160, touch sensors of a diamond form are arranged in a matrix form.

Referring to FIG. 4, in the two transparent conductive layers 130 and 160, touch sensors of a bar form are arranged in a matrix form.

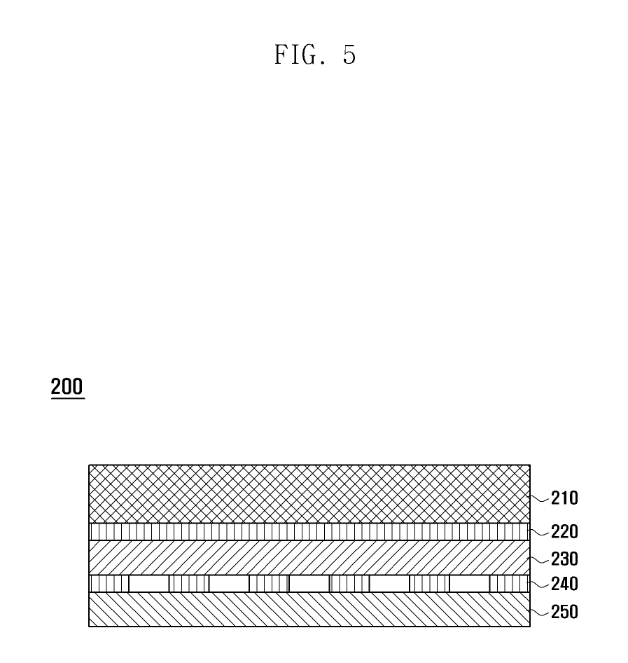

FIG. 5 is a cross-sectional view illustrating a C-type TSP according to an exemplary embodiment of the present invention.

Referring to FIG. 5, a TSP 200 includes a window 210, upper transparent conductive layer 220, transparent adhesive layer 230, lower transparent conductive layer 240, and transparent insulating substrate 250.

The window 210 is positioned at the uppermost side of the TSP 200, is a touch portion of a finger, and protects the TSP 200. The window 210 is formed with various transparent materials, such as plastic and glass.

The upper transparent conductive layer 220 is positioned between the window 210 and the transparent adhesive layer 230 and is used for detecting a position and action of a touch by detecting a user's touch to the window 210. The upper transparent conductive layer 220 is formed with ITO. However, a material of the upper transparent conductive layer 220 is not limited thereto.

The transparent adhesive layer 230 is positioned between the upper transparent conductive layer 220 and the lower transparent conductive layer 240 and is used for bonding the upper transparent conductive layer 220 and the lower transparent conductive layer 240. The transparent adhesive layer 230 is formed with OCA. However, a material of the transparent adhesive layer 230 is not limited thereto.

The lower transparent conductive layer 240 is positioned between the transparent adhesive layer 230 and the transparent insulating substrate 250 and is used for detecting a position and action of a touch by detecting a user's touch to the window 210. The lower transparent conductive layer 240 is formed with the same material as that of the upper transparent conductive layer 220. However, a material of the upper transparent conductive layer 220 is not limited thereto.

The transparent insulating substrate 250 is positioned at the lowermost side of the TSP 200 and functions as a substrate of the upper transparent conductive layer 220 and the lower transparent conductive layer 240. The transparent insulating substrate 250 is formed with polymer of an isotropic material. The transparent insulating substrate 250 is formed with PE or COC among polymer of an isotropic material. However, a material of the transparent insulating substrate 250 is not limited thereto.

The two transparent conductive layers 220 and 240 are arranged in a lattice method. For example, as shown in FIG. 3, in the two transparent conductive layers 220 and 240, touch sensors of a diamond form may be arranged in a matrix form, and as shown in FIG. 4, touch sensors of a bar form may be arranged in a matrix form.

As described above, according to exemplary embodiments of the present invention, by using polymer of an isotropic material as a substrate of a transparent conductive layer, an image distortion phenomenon can be reduced, thereby providing a good viewing environment to a user. More particularly, a TSP can be applied to an electronic device using a three-dimensional display.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A Capacitive type (C-type) Touch Screen Panel (TSP) comprising:
a window for protecting the TSP;
an upper transparent adhesive layer bonded under the window;
an upper transparent conductive layer bonded under the upper transparent adhesive layer and for detecting a touch point on the window;
an upper transparent insulating substrate disposed under the upper transparent conductive layer and formed with polymer of an isotropic material;
a lower transparent adhesive layer bonded under the upper transparent insulating substrate;
a lower transparent conductive layer bonded under the lower transparent adhesive layer and for detecting a touch point on the window; and
a lower transparent insulating substrate disposed under the lower transparent conductive layer and formed with polymer of an isotropic material.

2. The C-type TSP of claim 1, wherein each of the upper transparent insulating substrate and the lower transparent insulating substrate comprises PolyEthylene (PE) or Cyclic Olefin Copolymer (COC).

3. The C-type TSP of claim 1, wherein each of the upper transparent conductive layer and the lower transparent conductive layer comprises Indium Tin Oxide (ITO).

4. The C-type TSP of claim 3, wherein the upper transparent conductive layer and the lower transparent conductive layer are arranged in a lattice.

5. The C-type TSP of claim 1, wherein each of the upper transparent adhesive layer and the lower transparent adhesive layer comprises an Optically Clear Adhesive (OCA).

6. A Capacitive type (C-type) Touch Screen Panel (TSP) comprising:
a window for protecting the TSP;
an upper transparent conductive layer disposed under the window and for detecting a touch point on the window;
a transparent adhesive layer bonded under the upper transparent conductive layer;
a lower transparent conductive layer bonded under the transparent adhesive layer and for detecting a touch point on the window; and
a transparent insulating substrate disposed under the lower transparent conductive layer and formed with polymer of an isotropic material.

7. The C-type TSP of claim 6, wherein each of the upper transparent conductive layer and the lower transparent conductive layer comprises Indium Tin Oxide (ITO).

8. The C-type TSP of claim 7, wherein the upper transparent conductive layer and the lower transparent conductive layer are arranged in a lattice.

9. The C-type TSP of claim 6, wherein the adhesive layer comprises an Optically Clear Adhesive (OCA).

10. The C-type TSP of claim 6, wherein the transparent insulating substrate comprises PolyEthylene (PE) or Cyclic Olefin Copolymer (COC).
